(19) United States
(12) Patent Application Publication
(10) Pub. No.: US 2025/0379960 A1
(43) Pub. Date: Dec. 11, 2025

(54) ELECTRONIC DEVICE AND METHOD FOR CONTROLLING ELECTRONIC DEVICE

(71) Applicant: CANON KABUSHIKI KAISHA, Tokyo (JP)

(72) Inventor: MAKOTO IKEDA, Kanagawa (JP)

(21) Appl. No.: 19/225,523

(22) Filed: Jun. 2, 2025

(30) Foreign Application Priority Data
Jun. 5, 2024 (JP) 2024-091673

(51) Int. Cl. H04N 13/128; H04N 13/111; H04N 13/344

(52) U.S. Cl. CPC H04N 13/128; H04N 13/111; H04N 13/344

(57) ABSTRACT

An electronic device includes a communication interface and one or more processors configured to acquire a first image that is an image of a virtual object viewed from a first viewpoint and first depth information that is information regarding a distance in a depth direction when the virtual object is viewed from the first viewpoint; generate second depth information that is information regarding a distance in the depth direction when the virtual object is viewed from a second viewpoint having parallax with respect to the first viewpoint; generate a second image that is an image of the virtual object viewed from the second viewpoint; and generate a combined image of the second viewpoint in which a depth of the virtual object in a space viewed from the second viewpoint is expressed on a basis of the second depth information and the second image.

### BACKGROUND

### Technical Field

The present disclosure relates to an electronic device and a method for controlling the electronic device.

### Description of the Related Art

In recent years, a mixed reality (MR) technique is known as a technique for seamlessly merging a real world with a virtual world in real time. The MR technique is used in, for example, a video see-through head mounted display (HMD).

The HMD captures an image of an object observed from a pupil position of a user wearing the HMD with a video camera or the like, and displays an image in which computer graphics (CG) are superimposed and displayed on the captured image.

The video see-through HMD images an object by a charge coupled element, such as a CCD, and acquires digital image data of the object. The HMD displays a mixed reality image (MR image) obtained by superimposing a CG image on the acquired image data to a user via a liquid crystal display device, or an organic EL display device, or the like.

The HMD can receive a superimposed image obtained by superimposing a CG image on a captured image from an external apparatus and display the superimposed image. The HMD transmits a captured image captured by the HMD to an external apparatus. The external apparatus calculates the position and orientation of the HMD using the captured image received from the HMD. The external apparatus superimposes a CG image on the captured image on the basis of the calculated position and orientation of the HMD and transmits the superimposed image to the HMD. The HMD displays the superimposed image received from the external apparatus. A user wearing the HMD can observe an MR space by wearing the HMD.

Japanese Patent Application Publication No. 2019-95916 proposes a method in which an image generation apparatus transmits a computer graphics image together with depth information to an HMD, and the HMD superimposes the computer graphics image on a captured image of a real space to generate an augmented reality image.

However, when a CG image corresponding to left and right eyes and depth information are transmitted from an external apparatus such as an image generation apparatus to the HMD, a communication volume between the image generation apparatus and the HMD increases.

### SUMMARY

Embodiments of the present disclosure provide an electronic device capable of reducing a communication volume when receiving information for displaying a CG image from an external apparatus.

An electronic device according to an embodiment of the present disclosure includes a communication interface and one or more processors configured to execute an acquisition processing of acquiring, from an external apparatus, a first image that is an image of a virtual object viewed from a first viewpoint and first depth information that is information regarding a distance in a depth direction when the virtual object is viewed from the first viewpoint; execute an information generation processing of generating second depth information that is information regarding a distance in the depth direction when the virtual object is viewed from a second viewpoint having parallax with respect to the first viewpoint on a basis of the first depth information; and execute an image generation processing of generating a second image that is an image of the virtual object viewed from the second viewpoint on a basis of the first image and the first depth information and of generating a combined image of the second viewpoint in which a depth of the virtual object in a space viewed from the second viewpoint is expressed on a basis of the second depth information and the second image.

Further features of various embodiments will become apparent from the following description of exemplary embodiments with reference to the attached drawings.

### BRIEF DESCRIPTION OF THE DRAWINGS

FIG. 1 is a diagram for explaining a configuration of a system according to a first embodiment.

FIG. 2 is a block diagram of an HMD and an image processing apparatus according to the first embodiment.

FIG. 3 is another example of the block diagram of the HMD and the image processing apparatus according to the first embodiment.

FIGS. 4A to 4D are diagrams for explaining combining processing performed by a combining unit.

FIG. 5 is a flowchart illustrating image combining processing according to the first embodiment.

FIG. 6 is a block diagram of an HMD and an image processing apparatus according to a second embodiment.

FIG. 7 is a flowchart illustrating image combining processing according to the second embodiment.

FIG. 8 is a block diagram of an HMD and an image processing apparatus according to a third embodiment.

FIG. 9 is a block diagram of an HMD and an image processing apparatus according to a fourth embodiment.

FIGS. 10A to 10C are diagrams for explaining difference image information.

FIG. 11 is a flowchart illustrating image combining processing according to the fourth embodiment.

FIG. 12 is a diagram illustrating an example of a combination of a transmission capacity and transmission information.

### DESCRIPTION OF THE EMBODIMENTS

Hereinafter, embodiments of the present disclosure will be described with reference to the drawings.

### First Embodiment

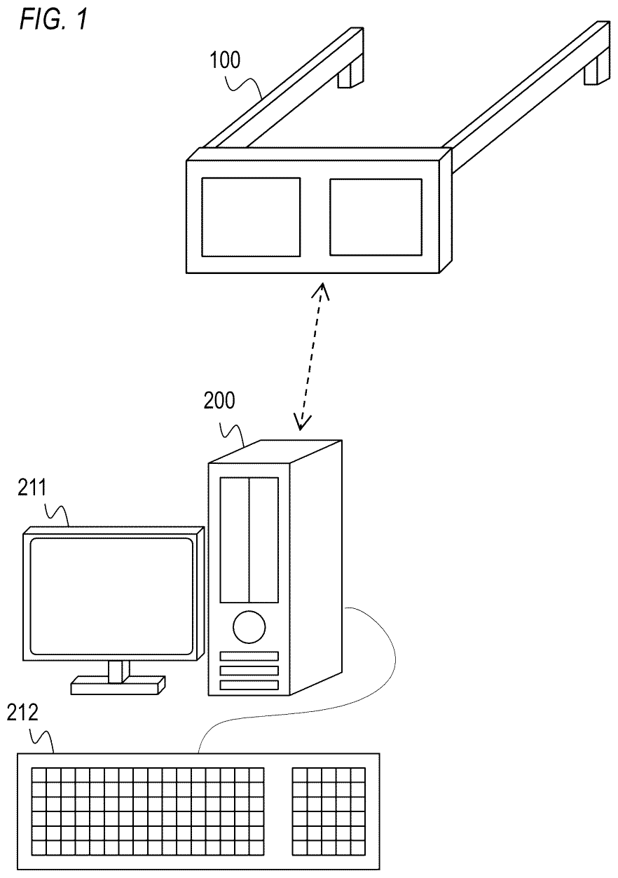

FIG. 1 is a diagram for explaining a configuration an image display system according to a first embodiment. The image display system illustrated in FIG. 1 includes a head mounted display (HMD) 100 that is an example of an electronic device according to the present disclosure and includes an image processing apparatus 200. The image processing apparatus 200 is connected to a display unit 211 and an operation unit 212.

The HMD 100 is worn on a head of a user. The HMD 100 can receive and display an image generated by the image processing apparatus 200. A display unit of the HMD 100 includes an optical system disposed in front of each of the left and right eyes of the user.

The HMD 100 can communicate with the image processing apparatus 200 via a small network, such as a wireless local area network (WLAN) or a wireless personal area network (WPAN). A wired communication method may be used between the HMD 100 and the image processing apparatus 200 without being limited to a wireless communication method.

The image processing apparatus 200 includes a storage unit that stores a content for allowing the user to experience MR. The content includes information for drawing CG (virtual object) disposed in a space viewed by the user. The image processing apparatus 200 can communicate with the HMD 100 in a wired or wireless manner.

The operation unit 212 connected to the image processing apparatus 200 is an input apparatus, such as a keyboard. The user can input data, a command, and the like using the operation unit 212. The display unit 211 displays data input by the user, a result of processing based on a command from the user, and the like.

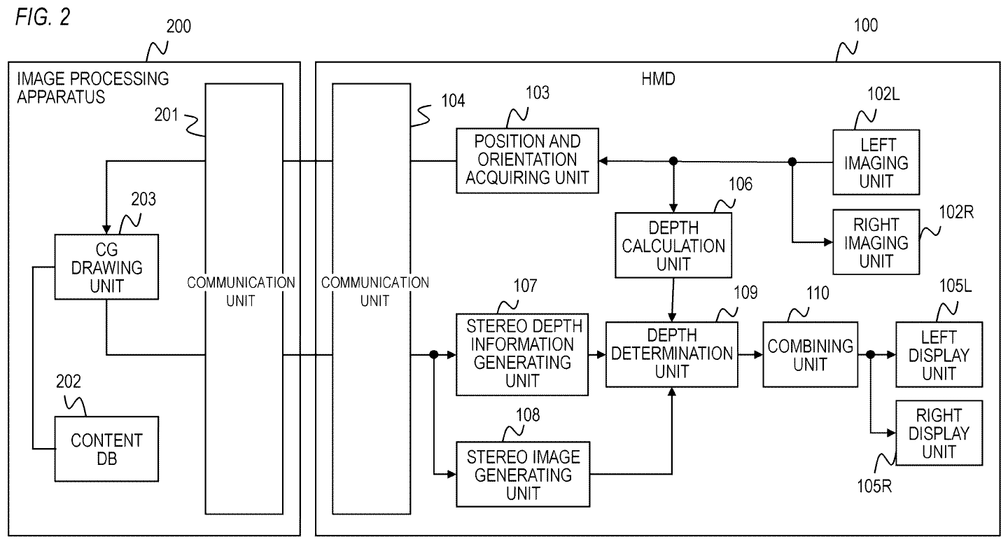

FIG. 2 is a block diagram of the HMD 100 and the image processing apparatus 200 according to the first embodiment. The HMD 100 includes a left imaging unit 102L, a right imaging unit 102R, a position and orientation acquiring unit 103, a communication unit 104, a left display unit 105L, a right display unit 105R, a depth calculation unit 106, a stereo depth information generating unit 107, a stereo image generating unit 108, a depth determination unit 109, and a combining unit 110.

The left imaging unit 102L and the right imaging unit 102R image an outside world from substantially the same position as the user's eyes. The left imaging unit 102L and the right imaging unit 102R are also collectively referred to as an imaging unit 102. The position and orientation acquiring unit 103 acquires information on the position and orientation of the HMD 100 from an external image captured by the imaging unit 102. The communication unit 104 is a communication interface for communicating with an external apparatus. The communication unit 104 transmits and receives various types of data, such as an image and depth information, and various control signals to and from an external apparatus, such as the image processing apparatus 200.

The left display unit 105L and the right display unit 105R display images (stereo images) to the user wearing the HMD 100. The left display unit 105L displays an image for the user's left eye, and the right display unit 105R displays an image for the user's right eye. The left display unit 105L and the right display unit 105R are also collectively referred to as a display unit 105.

The depth calculation unit 106 calculates the depth of a real object (object) in an image captured by the imaging unit 102, and generates stereo depth information of a real space. The stereo depth information generating unit 107 receives, from the image processing apparatus 200, depth information (first depth information) corresponding to an image (first image, image of a virtual object viewed from a first viewpoint) of CG (virtual object) viewed with one eye of the user. The first depth information is information regarding a distance in a depth direction when CG is viewed from the first viewpoint. The stereo depth information generating unit 107 generates second depth information that is information regarding a distance in the depth direction when the virtual object is viewed from a second viewpoint having parallax with respect to the first viewpoint on the basis of the received first depth information. The stereo depth information generating unit 107 can acquire stereo depth information of CG by generating the second depth information. The first depth information is depth information of the first image viewed with one eye of the user, and the second depth information is depth information of a second image (image having parallax with respect to the first image, image of CG viewed from the second viewpoint) viewed with the other eye of the user.

The stereo image generating unit 108 receives the first image of CG from the image processing apparatus 200. The stereo image generating unit 108 generates the second image having parallax with respect to the first image on the basis of the received first image and the first depth information received by the stereo depth information generating unit 107. The stereo image generating unit 108 can generate a stereo image of CG by generating the second image.

The depth determination unit 109 compares the depth of a real object in a space where CG is disposed with the depth of CG, and determines which is disposed on a back side. The combining unit 110 combines an image captured by the imaging unit 102 and a stereo image of CG generated by the stereo image generating unit 108. The stereo image combined by the combining unit 110 is displayed on the display unit 105.

The image processing apparatus 200 is an external apparatus different from the HMD 100, such as a personal computer (PC), a workstation (WS), or a cloud server via a public network, or the like. The image processing apparatus 200 includes a communication unit 201, a content DB 202, and a CG drawing unit 203.

The communication unit 201 transmits and receives various types of data, such as an image and depth information and various control signals, to and from the HMD 100. The content DB 202 stores a content of a virtual image. The CG drawing unit 203 draws CG according to the position and orientation of the HMD 100 using information on CG stored in the content DB 202.

The image processing apparatus 200 acquires information on the position and orientation of the HMD 100 from the HMD 100 and can draw CG of a virtual image. Note that the position and orientation of the HMD 100 may be measured by an external sensor. The image processing apparatus 200 acquires information on the position and orientation of the HMD 100 from an external sensor and can draw CG. In addition, the image processing apparatus 200 may acquire information on the position and orientation of the HMD 100, for example, from a captured image captured by the imaging unit 102 of the HMD 100.

When the information on the position and orientation of the HMD 100 is transmitted from the HMD 100 to the image processing apparatus 200, the position and orientation acquiring unit 103 can acquire the position and orientation of the HMD 100 on the basis of the captured image of the real space received from the imaging unit 102. The information on the position and orientation of the HMD 100 acquired by the position and orientation acquiring unit 103 is transmitted to the image processing apparatus 200 via the communication unit 104.

The CG drawing unit 203 of the image processing apparatus 200 draws a left-eye image and a right-eye image of CG on the basis of the received information on the position and orientation of the HMD 100. In the first embodiment, the image processing apparatus 200 transmits the left-eye image and the right-eye image of CG (stereo images of CG) to the HMD 100 via the communication unit 201.

The combining unit 110 of the HMD 100 combines the stereo image of CG received from the image processing apparatus 200 and the captured image (stereo image of the real space) captured by the imaging unit 102. For example, in the stereo image of CG, the combining unit 110 adopts the captured image captured by the imaging unit 102 in a predetermined chroma key color region, and adopts the stereo image of CG in a region other than the chroma key color.

Note that the combining unit 110 may receive an alpha value, which is information indicating transparency of CG, from the image processing apparatus 200 together with the stereo image of CG, and may combine the captured image captured by the imaging unit 102 and the stereo image of CG on the basis of the alpha value.

The image combined by the combining unit 110 is displayed on the display unit 105. By wearing the HMD 100, the user can view the combined image of the CG image drawn by the image processing apparatus 200 and the captured image captured by the imaging unit 102 in a state corresponding to the position and orientation of the user.

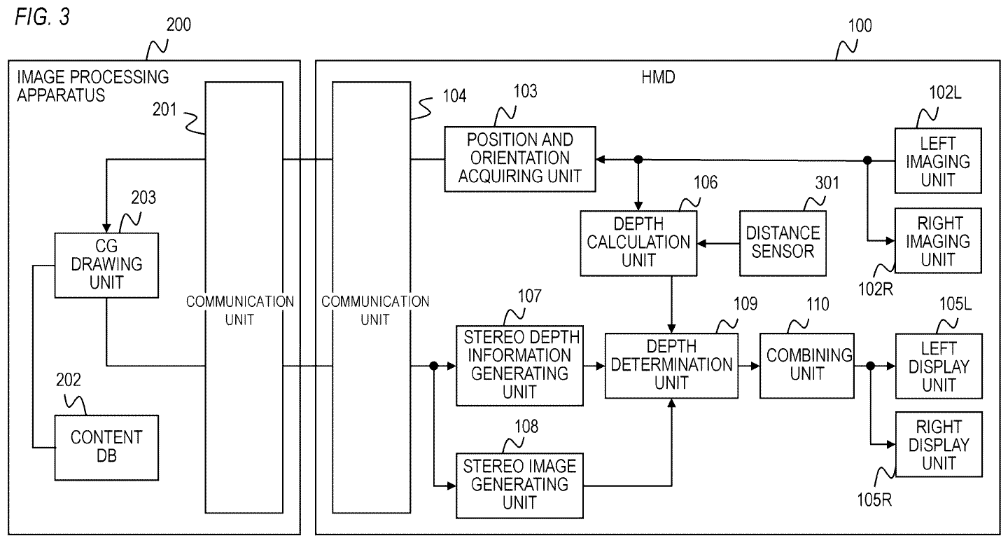

In FIG. 2, the depth calculation unit 106 acquires depth information of a real object in the real space (stereo depth information of the real space) on the basis of the captured image captured by the imaging unit 102. The depth calculation unit 106 may acquire the depth information of the real object in the real space by measuring a distance to the real object using a distance sensor 301 illustrated in FIG. 3 without being limited thereto.

FIG. 3 is another example of the block diagram of the HMD 100 and the image processing apparatus 200 according to the first embodiment. In the example of FIG. 3, the HMD 100 includes the distance sensor 301 in addition to the configuration illustrated in FIG. 2. The distance sensor 301 measures a distance to an object that is a real object. The depth calculation unit 106 acquires depth information of the real object imaged by the imaging unit 102 on the basis of a measurement result of the distance sensor 301. The distance sensor 301 is a sensor other than the imaging unit 102, and the distance sensor 301 includes a light detection and ranging sensor (LiDAR sensor), a time-of-flight sensor (ToF sensor), a millimeter wave radar, and the like. In the following description, it is assumed that the HMD 100 has the configuration of FIG. 2, and the depth calculation unit 106 acquires the depth information of the real object on the basis of the captured image captured by the imaging unit 102.

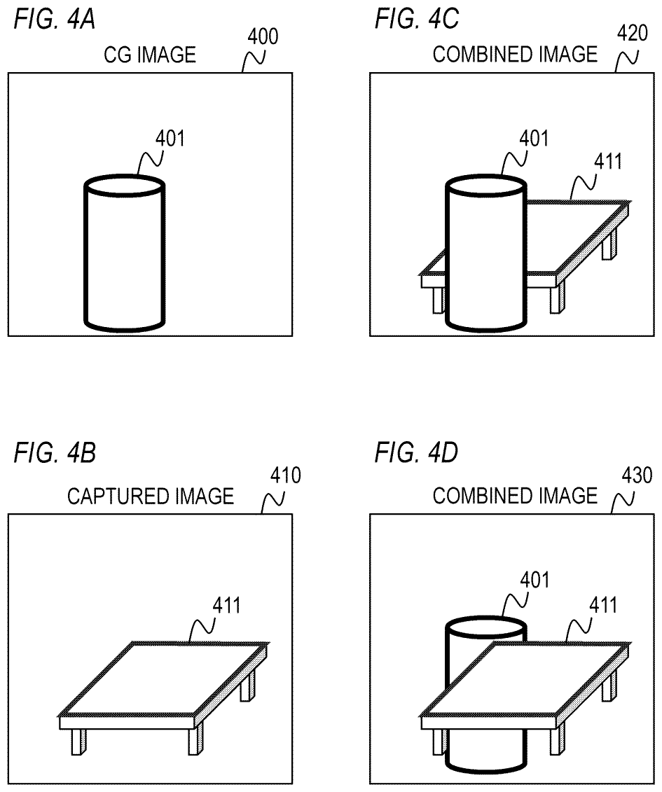

FIGS. 4A to 4D are diagrams for explaining combining processing performed by the combining unit 110. FIGS. 4A to 4D illustrate an example in which not images of both left eye and light eyes but an image on one eye side (for example, a left eye side) is combined. The combining unit 110 can also combine an image on a right eye side in a similar manner to the image on the left eye side.

FIG. 4A illustrates a CG image 400 received from the image processing apparatus 200. The CG image 400 includes a cylinder 401 that is CG. FIG. 4B illustrates a captured image 410 of the real space captured by imaging unit 102. The captured image 410 includes a table 411 that is a real object.

FIG. 4C illustrates a combined image 420 in a case where the cylinder 401 is in front of the table 411 (at a position close to the HMD 100). In the combined image 420, a part of the table 411 is hidden behind the cylinder 401. On the other hand, FIG. 4D illustrates a combined image 430 in a case where the cylinder 401 is on a back side of the table 411 (at a position far from the HMD 100). In the combined image 430, a part of the cylinder 401 is hidden behind the table 411. By using depth information from the HMD 100 to the cylinder 401 and depth information from the HMD 100 to the table 411, the combining unit 110 can generate a combined image in which the depth of the cylinder 401 is appropriately expressed in the real space.

A method for calculating depth information of a real object and CG will be described. First, calculation of the depth information of the real object will be described. The depth information of the real object can be acquired using a stereo image of a real space having parallax. The left imaging unit 102L and the right imaging unit 102R illustrated in FIG. 2 are disposed at similar positions to the user's eyes and can capture a stereo image of a real space having parallax. The depth calculation unit 106 calculates the depth of the real object using the stereo image of the real space captured by the imaging unit 102. The depth calculation unit 106 can calculate the depth of the real object from the two captured images having parallax by, for example, a sum of absolute difference (SAD) method or a semi global matching (SGM) method. The depth information is calculated for each pixel of the image.

Next, calculation of the depth information of CG will be described. The stereo image of CG is an image to be combined with a captured image and is an image having parallax similar to the captured image. The stereo depth information generating unit 107 receives the first depth information corresponding to an image (first image) of CG viewed with one eye of the user from the image processing apparatus 200, and the stereo depth information generating unit 107 performs perspective projection transformation on the first depth information. By transforming the first depth information by known perspective projection transformation, the stereo depth information generating unit 107 can generate the second depth information having parallax with respect to the first depth information. The second depth information is depth information corresponding to an image (second image) of CG viewed with the other eye of the user. The stereo depth information generating unit 107 acquires stereo depth information of CG by generating the second depth information from the first depth information.

The depth determination unit 109 compares the depth information of the real object in the real space calculated by the depth calculation unit 106 with the stereo depth information of CG generated by the stereo depth information generating unit 107, and the depth determination unit 109 determines which is closer to the HMD 100 for each pixel. The combining unit 110 performs combining processing by adopting an image closer to the HMD 100 between the real object and CG.

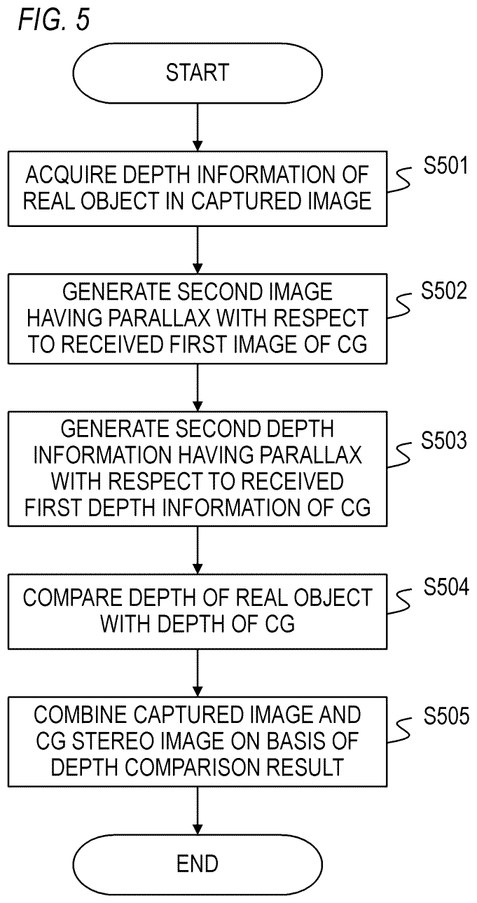

FIG. 5 is a flowchart illustrating image combining processing according to the first embodiment. The processing illustrated in FIG. 5 is processing of combining the captured image of the real space captured by the imaging unit 102 and the stereo image of CG disposed in the real space.

In step S501, the depth calculation unit 106 acquires depth information of the real object in the captured image. Specifically, first, the left imaging unit 102L and the right imaging unit 102R acquire two captured images (stereo images of the real space). Next, the depth calculation unit 106 obtains stereo depth information of the real space by calculating the depth of the real object (object) in the real space from the stereo image of the real space.

In step S502, the stereo image generating unit 108 generates, on the basis of an image (first image) of CG viewed with one eye of the user received from the image processing apparatus 200 and the first depth information corresponding to the first image, an image (second image) of CG viewed with the other eye. The second image is an image having parallax with respect to the first image. The stereo image generating unit 108 can acquire a stereo image of CG by generating the second image from the first image.

The stereo image generating unit 108 can generate the second image from the first image using a known method such as perspective projection transformation. The stereo image generating unit 108 may generate the second image from the first image using another known method without being limited to the perspective projection transformation.

In step S503, the stereo depth information generating unit 107 generates, from the first depth information corresponding to the image (first image) of CG viewed with one eye of the user received from the image processing apparatus 200, the second depth information corresponding to the image (second image) of CG viewed with the other eye. The second depth information is generated on the basis of the first depth information that is information regarding a distance in a depth direction when CG is viewed from the first viewpoint, and the second depth information is information regarding a distance in the depth direction when CG is viewed from the second viewpoint having parallax with respect to the first viewpoint. The stereo depth information generating unit 107 can acquire stereo depth information of CG by generating the second depth information from the first depth information.

In step S504, the depth determination unit 109 compares the depth of the real object in the real space with the depth of CG. The depth determination unit 109 compares the depth for each pixel of the image on the basis of the depth information of the real object in the real space (stereo depth information of the real space) acquired by the depth calculation unit 106 and the stereo depth information of CG generated by the stereo depth information generating unit 107.

In step S505, the combining unit 110 combines the captured image of the real space and the stereo image of CG on the basis of a comparison result between the depth of the real object and the depth of CG in step S504. By adopting an image closer to the HMD 100 out of the real object and CG, the combining unit 110 combines the captured image and the stereo image of CG into one image. In step S505, the combining unit 110 generates, on the basis of the first depth information and the first image, a combined image of the first viewpoint in which the depth of CG in the real space viewed from the first viewpoint is expressed (combined image of the image of the real space and the image of CG). Furthermore, on the basis of the second depth information and the second image, the combining unit 110 generates a combined image of the second viewpoint in which the depth of CG in the real space viewed from the second viewpoint is expressed (combined image of the image of the real space and the image of CG). The combining unit 110 generates the combined image of the first viewpoint and the combined image of the second viewpoint on the basis of the captured image obtained by imaging the real space, and the combining unit 110 can generate a stereo image in which the depth of CG in the real space (mixed reality space) is appropriately expressed.

In the second image generated in step S502 and the second depth information generated in step S503, there may be a state in which information on an occlusion region that is not visible in the received first image and first depth information is missing.

The stereo image generating unit 108 may interpolate a missing region in the second image on the basis of information of surrounding pixels. The stereo image generating unit 108 can interpolate the missing region using, for example, an inpainting technique. In addition, the stereo depth information generating unit 107 may interpolate a missing portion of the second depth information on the basis of depth information of surrounding pixels.

In the first embodiment, the HMD 100 receives the first depth information corresponding to the image (first image) of CG viewed with one eye of the user from the image processing apparatus 200, and the HMD 100 generates the second depth information corresponding to the image (second image) viewed with the other eye by perspective projection transformation using the first depth information. The HMD 100 may acquire depth information of an image viewed with each of the left and right eyes by receiving depth information at a viewpoint between the left eye and the right eye and performing perspective projection transformation using the received depth information without being limited thereto.

In the first embodiment described above, the HMD 100 receives the image (first image) of CG viewed with one eye of the user and the first depth information corresponding to the first image from the image processing apparatus 200. The HMD 100 generates the second image viewed with the other eye of the user and the second depth information corresponding to the second image on the basis of the received first image and first depth information. The HMD 100 can generate an image in which the depth of CG in the real space is appropriately expressed using a stereo image of CG based on the first image and the second image and stereo depth information of CG based on the first depth information and the second depth information. As described above, the HMD 100 can generate an image in which the depth of CG is appropriately expressed without receiving the second image corresponding to one eye and the second depth information from the image processing apparatus 200, and therefore can suppress a communication volume with the image processing apparatus 200.

### Second Embodiment

In the first embodiment, by receiving only an image of CG corresponding to one eye and depth information from the image processing apparatus 200 in the MR system, the HMD 100 can generate an image correctly expressing a depth relationship between the real space and CG. A second embodiment is an embodiment in which an image correctly expressing a depth relationship between the real space and CG is generated while a communication volume with an image processing apparatus 200 is suppressed in a virtual reality (VR) system.

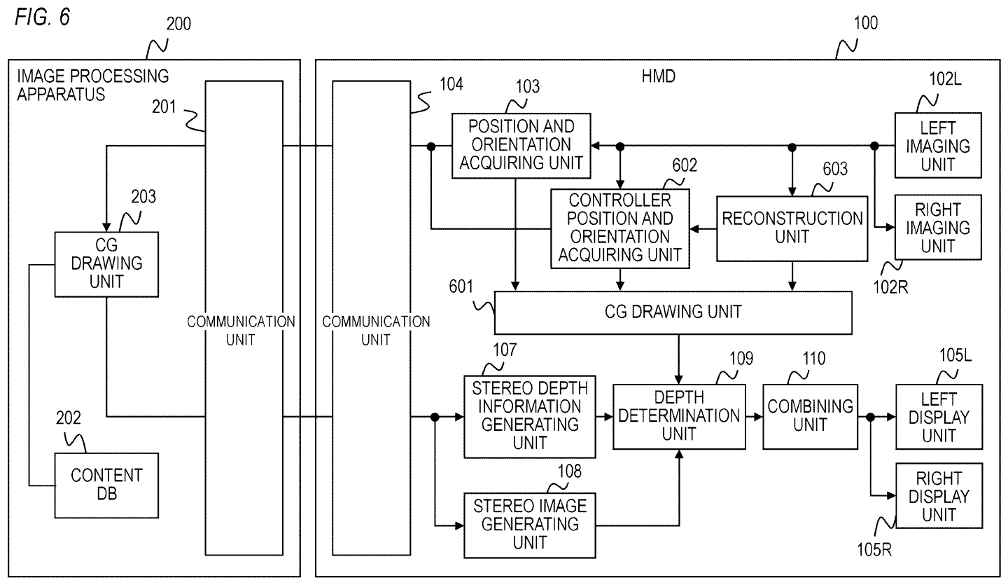

FIG. 6 is a block diagram of an HMD 100 and the image processing apparatus 200 according to the second embodiment. Components different from the components of the HMD 100 and the image processing apparatus 200 according to the first embodiment (FIG. 2) will be described. The HMD 100 according to the second embodiment includes a CG drawing unit 601, a controller position and orientation acquiring unit 602, and a reconstruction unit 603 instead of the depth calculation unit 106.

The CG drawing unit 601 receives information on the position and orientation of the HMD 100 acquired by a position and orientation acquiring unit 103, and the CG drawing unit 601 can draw CG different from CG received from the image processing apparatus 200.

The position and orientation acquiring unit 103 can calculate the position and orientation of the HMD 100 from a captured image captured by an imaging unit 102, but the position and orientation acquiring unit 103 may acquire the position and orientation of the HMD 100 by another method. For example, the position and orientation acquiring unit 103 may acquire information on the position and orientation of the HMD 100 by receiving information measured by an external sensor or the like. In addition, the position and orientation acquiring unit 103 may measure the position and orientation of the HMD 100 using a 6 degree of freedom (DoF) sensor, a 3 DoF sensor, or the like disposed separately from the imaging unit 102.

The controller position and orientation acquiring unit 602 acquires information on the position and orientation of a controller for operating the HMD 100. The controller is communicably connected to the HMD 100 and held by a hand of a user wearing the HMD 100.

The controller position and orientation acquiring unit 602 can acquire information on the position and orientation of the controller from a captured image of the controller captured by the imaging unit 102. Note that the controller position and orientation acquiring unit 602 may acquire the information on the position and orientation of the controller by receiving information measured by an external sensor or the like. In addition, the controller position and orientation acquiring unit 602 may acquire the information on the position and orientation of the controller by receiving the position and orientation calculated by the controller from the controller.

The reconstruction unit 603 executes three-dimensional reconstruction on the basis of the captured image captured by the imaging unit 102 and generates a reconstruction model. The reconstruction unit 603 can perform the three-dimensional reconstruction by a known method, but the reconstruction method is not particularly limited. The reconstruction unit 603 may extract a three-dimensional reconstruction model of the hand of the user wearing the HMD 100 as post-processing by a known method. The reconstruction unit 603 can generate the reconstruction model, for example, in any form of polygon, voxel, and point cloud.

The CG drawing unit 601 can draw CG using the position and orientation of the HMD 100 acquired by the position and orientation acquiring unit 103, the position and orientation of the controller acquired by the controller position and orientation acquiring unit 602, the information on the reconstruction model generated by the reconstruction unit 603, and the like.

In the example of FIG. 6, the HMD 100 and the image processing apparatus 200 include the CG drawing unit 601 and a CG drawing unit 203, respectively. For example, it is assumed that the CG drawing unit 203 of the image processing apparatus 200 draws CG of the entire screen, and the CG drawing unit 601 of the HMD 100 draws simple CG of a controller held by the user's hand or the like.

The CG drawing unit 601 transmits the drawn CG and depth information of the CG to a depth determination unit 109. The depth determination unit 109 compares stereo depth information of CG (CG received from the image processing apparatus 200) generated by a stereo depth information generating unit 107 with stereo depth information of CG drawn by the CG drawing unit 601, and the depth determination unit 109 determines which CG is closer to the HMD 100.

The combining unit 110 combines, on the basis of a comparison result between the depth of CG (first CG) drawn by the CG drawing unit 601 and the depth of CG (second CG) received from the image processing apparatus 200, a stereo image of the first CG and a stereo image of the second CG. By adopting an image closer to the HMD 100 out of the first CG and the second CG, the combining unit 110 combines the stereo image of the first CG and the stereo image of the second CG. As a result, the combining unit 110 can generate an image in which a depth relationship between the two CGs is expressed.

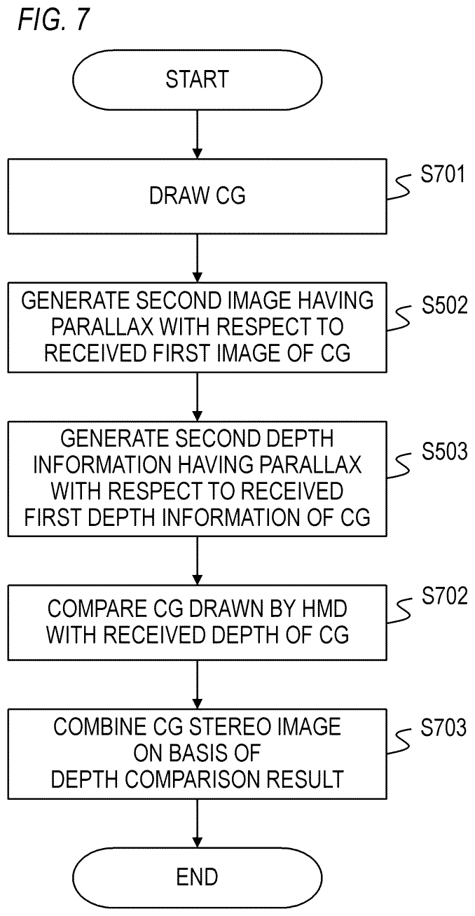

FIG. 7 is a flowchart illustrating image combining processing according to the second embodiment. The same processes as those in the image combining processing according to the first embodiment in FIG. 5 are denoted by the same reference numerals, and a detailed description thereof is omitted.

In step S701, the CG drawing unit 601 draws CG on the basis of the position and orientation of the HMD 100, the position and orientation of the controller, the reconstruction model, and the like.

In step S502, as described in FIG. 5, a stereo image generating unit 108 acquires a stereo image of CG by generating a second image from a first image. In step S503, the stereo depth information generating unit 107 acquires stereo depth information of CG by generating second depth information from first depth information.

In step S702, the depth determination unit 109 compares the stereo depth information of CG (first CG) drawn by the CG drawing unit 601 with the stereo depth information of CG (second CG) received from the image processing apparatus 200 for each pixel of the image.

In step S703, the combining unit 110 combines the stereo image of the first CG and the stereo image of the second CG on the basis of the comparison result between the depth of the first CG and the depth of the second CG in step S702. By adopting an image closer to the HMD 100 out of the first CG and the second CG, the combining unit 110 combines the stereo image of the first CG and the stereo image of the second CG into one image.

In the second embodiment described above, similarly to the first embodiment, the HMD 100 receives an image (first image) of CG viewed with one eye of the user and first depth information corresponding to the first image from the image processing apparatus 200. The HMD 100 generates the second image viewed with the other eye of the user and the second depth information corresponding to the second image on the basis of the received first image and first depth information. That is, by receiving a part of information of CG (second CG) from the image processing apparatus 200, the HMD 100 can acquire a stereo image and stereo depth information of the CG (second CG).

The HMD 100 combines a stereo image of the second CG and a stereo image of the first CG on the basis of the stereo depth information of the second CG and stereo depth information of CG (first CG) drawn by the HMD 100. As a result, the HMD 100 can generate an image in which a depth relationship between the second CG (partially received) from the image processing apparatus 200 and the first CG drawn by the HMD 100 is appropriately expressed.

Even when the HMD 100 does not receive the second image and the second depth information of CG (second CG) from the image processing apparatus 200, the HMD 100 can generate an image in which the depth of the CG (second CG) is appropriately expressed, and the HMD 100 can suppress a communication volume with the image processing apparatus 200.

Note that the CG (first CG) drawn by the HMD 100 may be CG representing a virtual space provided in the VR system. In this case, in step S703, the combining unit 110 generates, on the basis of the first depth information and the first image, a combined image of the first viewpoint in which the depth of the second CG in the virtual space viewed from the first viewpoint is expressed (combined image of the image of the virtual space and the image of the second CG). Furthermore, on the basis of the second depth information and the second image, the combining unit 110 generates a combined image of the second viewpoint in which the depth of the second CG in the virtual space viewed from the second viewpoint is expressed (combined image of the image of the virtual space and the image of the second CG). The combining unit 110 can generate the combined image of the first viewpoint and the combined image of the second viewpoint on the basis of the image of the virtual space, and the combining unit 110 can generate a stereo image in which the depth of CG in the virtual space is appropriately expressed.

### Third Embodiment

In the first and second embodiments, the HMD 100 generates, from the first depth information corresponding to the image (first image) of CG viewed with one eye of a user, the second depth information corresponding to the image (second image) of CG viewed with the other eye. In a third embodiment, an HMD 100 generates, from a stereo image of CG (a first image and a second image) generated from the first image of CG and first depth information, second depth information corresponding to the second image. That is, the HMD 100 acquires stereo depth information of CG by generating the second depth information corresponding to the second image on the basis of the stereo image of CG.

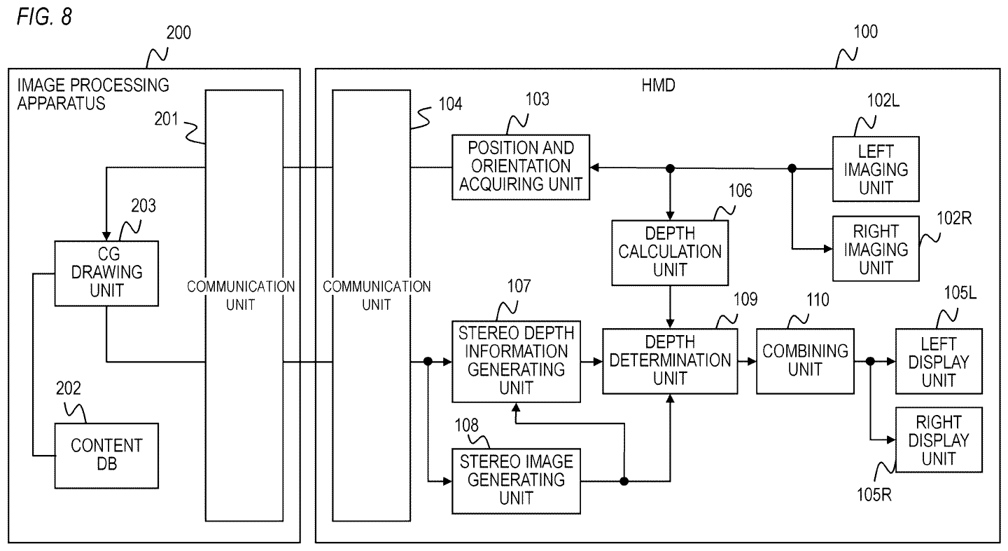

FIG. 8 is a block diagram of the HMD 100 and an image processing apparatus 200 according to the third embodiment. Configurations of the HMD 100 and the image processing apparatus 200 according to the third embodiment are different from the configurations of the first embodiment illustrated in FIG. 2 in that a stereo image of CG generated by a stereo image generating unit 108 is transmitted to a stereo depth information generating unit 107. The stereo depth information generating unit 107 generates, from a received stereo image of CG (two images having parallax), second depth information corresponding to an image (second image) of CG viewed with the other eye as in the case of the captured image. A method for generating the depth information may be SAD, SGM, or the like as in the case of the stereo depth information of the real space obtained from two captured images, and is not particularly limited.

In the third embodiment described above, similarly to the first embodiment, the HMD 100 receives an image (first image) of CG viewed with one eye of the user and first depth information corresponding to the first image from the image processing apparatus 200. In addition, unlike the first embodiment, the HMD 100 according to the third embodiment generates, from a stereo image of CG (a first image and a second image) generated from the first image of CG and the first depth information, the second depth information corresponding to the second image.

Even when the HMD 100 does not receive the second image and the second depth information from the image processing apparatus 200 and generates the second depth information on the basis of a stereo image of CG, the HMD 100 can generate an image in which the depth of CG is appropriately expressed. In addition, the HMD 100 can suppress a communication volume with the image processing apparatus 200.

### Fourth Embodiment

In the first to third embodiments, the HMD 100 receives the image (first image) of CG viewed with one eye of a user and the first depth information corresponding to the first image from the image processing apparatus 200, and the HMD 100 generates the image (second image) of CG viewed with the other eye and the second depth information corresponding to the second image. That is, the HMD 100 acquires, from the image processing apparatus 200, the first image that is an image of a virtual object viewed from a first viewpoint and the first depth information that is information regarding a distance in a depth direction when CG is viewed from the first viewpoint. Then, the HMD 100 generates the second depth information that is information regarding a distance in the depth direction when CG is viewed from a second viewpoint on the basis of the first depth information.

On the other hand, in a fourth embodiment, an HMD 100 receives, in addition to a first image, difference image information that is a difference between the first image and a second image from an image processing apparatus 200. The difference image information is information of a difference image related to an image region that is invisible when viewed from a first viewpoint among CGs viewed from a second viewpoint having parallax with respect to the first viewpoint. The HMD 100 generates a stereo image of CG by generating a second image (an image in which CG is viewed from the second viewpoint) on the basis of the first image and the difference image information.

In addition to the first depth information, the HMD 100 may receive difference depth information that is a difference between the first depth information and the second depth information from the image processing apparatus 200. The HMD 100 can generate stereo depth information of CG by generating the second depth information on the basis of the first depth information and the difference depth information.

The HMD 100 according to the fourth embodiment can acquire the stereo image of CG and the stereo depth information of the CG by receiving a difference between the first image and the first depth information without receiving the second image and the second depth information from the image processing apparatus 200. Therefore, the HMD 100 can generate an image in which the depth of CG is expressed.

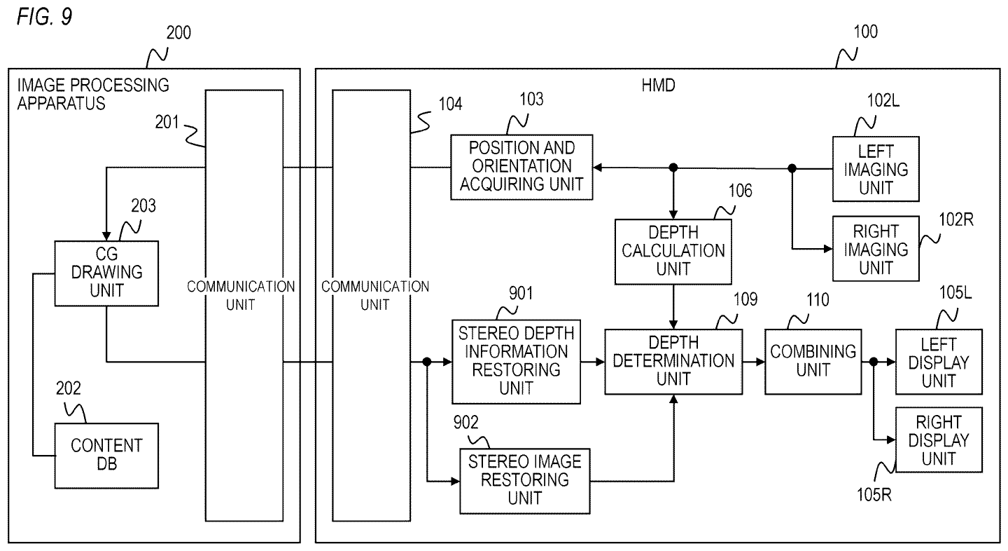

FIG. 9 is a block diagram of the HMD 100 and the image processing apparatus 200 according to the fourth embodiment. Components different from the components of the HMD 100 and the image processing apparatus 200 according to the first embodiment (FIG. 2) will be described. The HMD 100 according to the fourth embodiment includes a stereo depth information restoring unit 901 and a stereo image restoring unit 902 instead of the stereo depth information generating unit 107 and the stereo image generating unit 108.

In the following description, a reference image (first image) to be transmitted to the HMD 100 by the image processing apparatus 200 is an image of CG viewed with a left eye of a user. The image processing apparatus 200 transmits a reference image of CG viewed with a left eye and difference image information between an image (second image) of CG viewed with a right eye and the reference image to the HMD 100. Note that the reference image may be an image of CG viewed with a right eye of the user.

The image processing apparatus 200 transmits a CG image for the left eye and transmits difference image information that is a difference between the CG image for the left eye and a CG image for the right eye to the HMD 100. In addition, the image processing apparatus 200 transmits depth information corresponding to the CG image for the left eye and transmits difference depth information that is a difference between depth information corresponding to the CG image for the right eye and depth information corresponding to the CG image for the left eye to the HMD 100.

The stereo depth information restoring unit 901 restores (generates) the depth information corresponding to the CG image for the right eye on the basis of the depth information corresponding to the CG image for the left eye and the difference depth information, and the stereo depth information restoring unit 901 generates stereo depth information of CG. The stereo image restoring unit 902 restores (generates) the CG image for the right eye on the basis of the CG image for the left eye and the difference image information, and the stereo image restoring unit 902 generates a stereo image of CG.

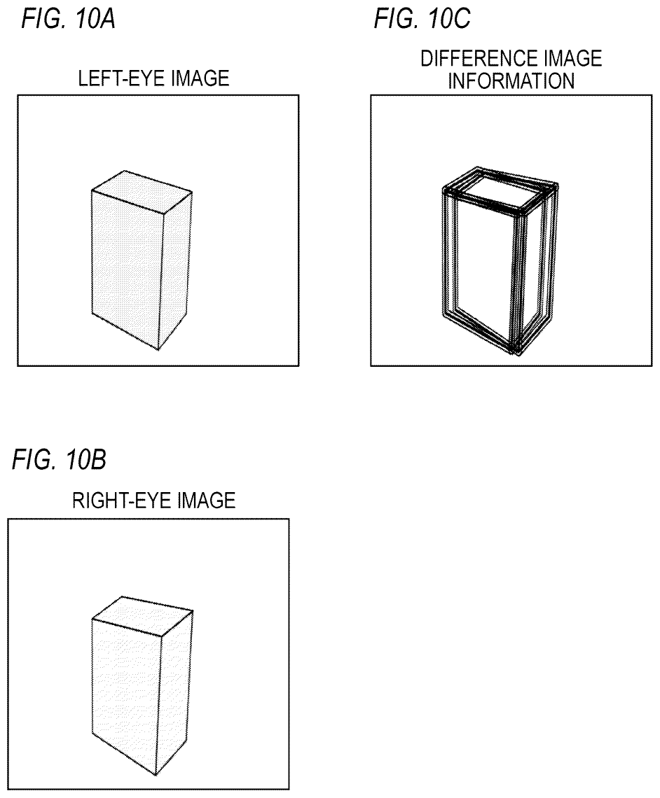

FIGS. 10A to 10C are diagrams for explaining the difference image information. FIGS. 10A to 10C illustrate left and right CG images and difference image information when CG of a rectangular parallelepiped is drawn. FIGS. 10A and 10B illustrate a CG image for the left eye and a CG image for the right eye generated by the image processing apparatus 200, respectively. FIG. 10C illustrates difference image information that is a difference between the CG image for the left eye and the CG image for the right eye.

In general, there is a high correlation between a left-eye image and a right-eye image that are stereo images. Therefore, the image processing apparatus 200 can reduce a transmission volume by transmitting difference image information between the left-eye image and the right-eye image without transmitting the right-eye image to the HMD 100. The HMD 100 can generate a stereo image of CG by receiving the CG image for the left eye that is a reference image and the difference image information from the image processing apparatus 200.

Similarly, there is a high correlation between depth information corresponding to the left-eye image (left-eye depth information) and depth information corresponding to the right-eye image (right-eye depth information), which are stereo depth information. Therefore, the image processing apparatus 200 can reduce the transmission volume by transmitting difference depth information between the left-eye depth information and the right-eye depth information without transmitting the right-eye depth information to the HMD 100. The HMD 100 can generate stereo depth information of CG by receiving the left-eye depth information as reference depth information and the difference depth information from the image processing apparatus 200. The HMD 100 can generate an image expressing the depth of CG on the basis of the generated stereo image and stereo depth information.

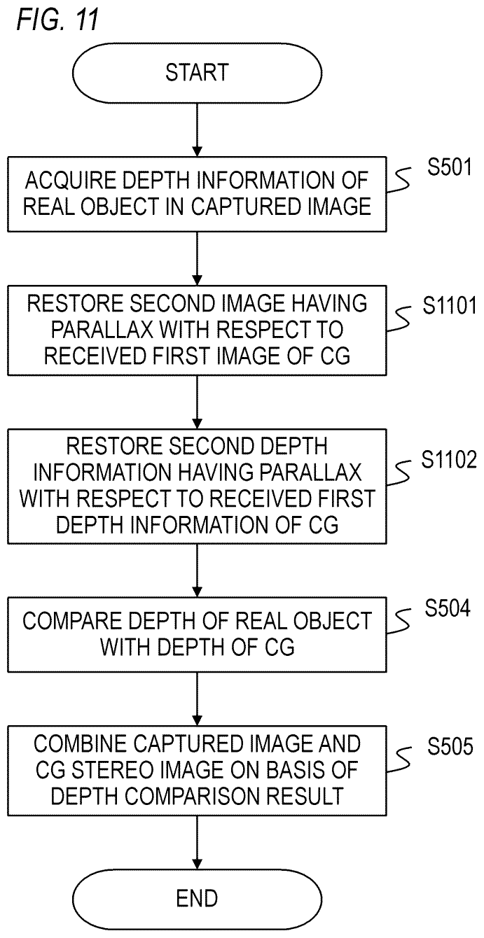

FIG. 11 is a flowchart illustrating image combining processing according to the fourth embodiment. In the image combining processing illustrated in FIG. 11, the HMD 100 generates a stereo image of CG using the left-eye image and the difference image information received from the image processing apparatus 200. In addition, the HMD 100 generates stereo depth information of CG using the left-eye depth information and the difference depth information received from the image processing apparatus 200. The same processes as those in the image combining processing according to the first embodiment in FIG. 5 are denoted by the same reference numerals, and a detailed description thereof is omitted.

In step S501, as described in FIG. 5, the depth calculation unit 106 acquires depth information of a real object in a captured image (stereo image of the real space). In step S1101, the stereo image restoring unit 902 restores (generates) a CG image for the right eye on the basis of a CG image for the left eye and difference image information that is a difference between the CG image for the right eye and the CG image for the left eye. In step S1102, the stereo depth information restoring unit 901 restores (generates) right-eye depth information corresponding to the CG image for the right eye on the basis of the left-eye depth information corresponding to the CG image for the left eye and on the difference depth information that is a difference between the right-eye depth information and the left-eye depth information.

Note that the HMD 100 may execute the process of step S502 in FIG. 5 instead of the process of step S1101 and execute the process of step S1102. That is, the HMD 100 may generate a stereo image of CG by generating the CG image for the right eye on the basis of the CG image for the left eye and the left-eye depth information without receiving the difference image information from the image processing apparatus 200.

In addition, after executing the process of step S1101, the HMD 100 may execute the process of step S503 in FIG. 5 instead of the process of step S1102. That is, the HMD 100 may generate the stereo depth information of CG by generating the right-eye depth information from the left-eye depth information without receiving the difference depth information from the image processing apparatus 200.

What kind of information is used to generate or restore the CG image for the right eye and the right-eye depth information may be determined at the time of connection between the image processing apparatus 200 and the HMD 100. For example, the HMD 100 may determine a method for generating/restoring the CG image for the right eye and the right-eye depth information on the basis of an operation from the user, or the HMD 100 may determine the method on the basis of a communication status with the image processing apparatus 200.

In addition, the image processing apparatus 200 may transmit data indicating the type of information to be transmitted together with information to be transmitted to the HMD 100. The HMD 100 can determine a method for generating/restoring the CG image for the right eye and the right-eye depth information according to a content of the information received from the image processing apparatus 200. If the HMD 100 has not received the difference image information, the HMD 100 only needs to perform the process of step S502 instead of the process of step S1101. If the HMD has not received the difference depth information, the HMD 100 only needs to perform the process of step S503 instead of the process of step S1102.

In addition, when transmitting the difference image information and the difference depth information to the HMD 100, the image processing apparatus 200 can further reduce the transmission volume by compressing the difference information using a method such as encoding.

In the fourth embodiment described above, the HMD 100 receives the CG image for the left eye that is a reference image and receives the difference image information that is a difference between the CG image for the left eye and the CG image for the right eye from the image processing apparatus 200. In addition to the depth information for the left eye, the HMD 100 receives the difference image information that is a difference between the depth information for the left eye and the depth information for the right eye from the image processing apparatus 200. The image processing apparatus 200 can also reduce the communication volume by transmitting the difference image information instead of the CG image for the right eye and transmitting the difference depth information instead of the depth information for the right eye. In addition, by generating a stereo image of CG using the CG image for the left eye, the difference image information, the depth information for the left eye, and the difference depth information, and by combining the stereo image with a captured image of the real space, the HMD 100 can generate a combined image in which the depth of CG is appropriately expressed.

### Fifth Embodiment

In the first to third embodiments, the HMD 100 generates an image in which the depth of CG is appropriately expressed by receiving the image (first image) of CG viewed with one eye of a user and the first depth information corresponding to the first image from the image processing apparatus 200. In addition, in the fourth embodiment, by further receiving the difference image information and the difference depth information, the HMD 100 generates an image in which the depth of CG is appropriately expressed.

In a fifth embodiment, an HMD 100 generates a stereo depth information of CG and a stereo image of CG, and the HMD 100 changes information acquired from an image processing apparatus 200 in order to generate an image in which the depth of CG is appropriately expressed according to a predetermined condition. The predetermined condition includes, for example, a condition for a transmission capacity with the image processing apparatus 200 and a condition for a distance to CG.

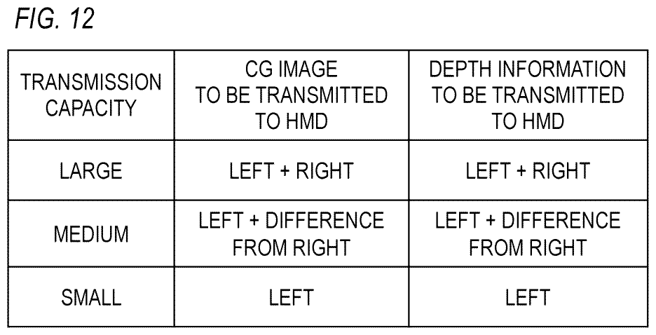

An example of a case where the predetermined condition is a condition for a transmission capacity between the HMD 100 and the image processing apparatus 200 will be described with reference to FIG. 12. FIG. 12 is a diagram illustrating an example of a combination of a transmission capacity between the image processing apparatus 200 and the HMD 100 and transmission data to be transmitted from the image processing apparatus 200 to the HMD 100. FIG. 12 illustrates three combinations according to the transmission capacity, but the combination of the transmission capacity and the transmission information is not limited thereto.

In a case of wireless connection, the transmission capacity is assumed to vary depending on, for example, radio wave interference and a congestion degree. In a case of wired connection, the transmission capacity is assumed to vary depending on, for example, a cable length and cable quality. In each of “large”, “medium”, and “small” of the transmission capacity, a range of a corresponding transmission capacity is set in advance according to various assumed conditions.

When the transmission capacity is “large”, in order to prioritize image quality of CG, the image processing apparatus 200 transmits left and right CG images (stereo images of CG) and left and right depth information (stereo depth information of CG) to the HMD 100. The HMD 100 generates a combined image of a captured image (stereo image of the real space) and a stereo image of CG using the received left and right CG images and left and right depth information.

When the transmission capacity is “medium”, the image processing apparatus 200 transmits a CG image for the left eye, difference image information, depth information for the left eye, and difference depth information to the HMD 100 as described in the fourth embodiment. By generating a CG image for the right eye and depth information for the right eye using the received information, the HMD 100 generates a stereo image of CG and stereo depth information of CG.

When the transmission capacity is “small”, the image processing apparatus 200 transmits only the CG image for the left eye and the depth information for the left eye to the HMD 100. As described in the first embodiment, by generating a CG image for the right eye and depth information for the right eye using the received information, the HMD 100 generates a stereo image of CG and stereo depth information of CG.

A timing at which the transmission capacity is determined includes, for example, a timing at which the image processing apparatus 200 is started, a timing at which the HMD 100 is started, and a timing at which an application for drawing CG is started. The timing at which the transmission capacity is determined may be a timing at which a communication state changes by monitoring the communication state. Determination of the transmission capacity may be executed by the image processing apparatus 200 or may be executed by the HMD 100.

For example, when the transmission capacity is determined by the HMD 100, the HMD 100 changes information acquired from the image processing apparatus 200 according to the transmission capacity. The HMD 100 notifies the image processing apparatus 200 of the type of information acquired from the image processing apparatus 200. The image processing apparatus 200 changes information to be transmitted to the HMD 100 on the basis of the type of information of which the image processing apparatus 200 is notified.

When the image processing apparatus 200 determines the transmission capacity, the image processing apparatus 200 changes information to be transmitted to the HMD 100 according to the transmission capacity. The image processing apparatus 200 notifies the HMD 100 of the type of information to be transmitted to the HMD 100.

The type of information to be transmitted and received between the image processing apparatus 200 and the HMD 100 may be changed for each frame. In this case, the image processing apparatus 200 adds data indicating the type of information included in each frame of an image to be transmitted to each frame.

Note that the predetermined condition for determining whether or not to change the information acquired from the image processing apparatus 200 is not limited to the transmission capacity between the image processing apparatus 200 and the HMD 100. For example, the predetermined condition may be a condition for a distance to CG. In CG present at a position away from the HMD 100, parallax between the left-eye image and the right-eye image is further reduced. Therefore, in a case where CG is present at a position away from the HMD 100, the HMD 100 can generate an image in which the depth of CG is appropriately expressed even when only an image of CG viewed with one eye of the user and corresponding depth information are received.

In the fifth embodiment described above, the type of information to be transmitted from the image processing apparatus 200 to the HMD 100 is appropriately changed according to a predetermined condition, and therefore the transmission capacity between the image processing apparatus 200 and the HMD 100 is reduced. Therefore, the transmission capacity between the image processing apparatus 200 and the HMD 100 is reduced, and the HMD 100 can generate an image in which the depth of CG is appropriately expressed.

The first to fifth embodiments described above indicate an example in which a stereo image, in which the depth of CG in a space is appropriately expressed, is generated using a stereo image of CG based on the first image and the second image and using stereo depth information of CG based on the first depth information and the second depth information. In this case, on the basis of the first depth information and the first image, the HMD 100 generates a combined image of the first viewpoint in which the depth of CG in a space viewed from the first viewpoint is expressed (combined image of the image of the space and the image of CG). Furthermore, on the basis of the second depth information and the second image, the HMD 100 generates a combined image of the second viewpoint in which the depth of CG in a space viewed from the second viewpoint is expressed (combined image of the image of the space and the image of CG).

Note that the HMD 100 may receive the combined image of the first viewpoint in which the depth of CG in the space viewed from the first viewpoint is expressed from an external apparatus without being limited to generating the combined image of the first viewpoint and the combined image of the second viewpoint. In this case, on the basis of the second depth information and the second image, the HMD 100 needs only to generate a combined image of the second viewpoint in which the depth of CG in a space viewed from the second viewpoint is expressed.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiments described above (including variation examples) are merely examples. Any configurations obtained by suitably modifying or changing some configurations of the embodiments within the scope of the subject matter of the present disclosure are also included in some embodiments. Some embodiments also include other configurations obtained by suitably combining various features of the embodiments.

According to the present disclosure, it is possible to reduce a communication volume at the time of receiving information for displaying a CG image from an external apparatus.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-091673, which was filed on Jun. 5, 2024 and which is hereby incorporated by reference herein in its entirety.

What is claimed is:

1. An electronic device comprising:
a communication interface; and
one or more processors configured to:
execute an acquisition processing of acquiring, from an external apparatus, a first image that is an image of a virtual object viewed from a first viewpoint and first depth information that is information regarding a distance in a depth direction when the virtual object is viewed from the first viewpoint;
execute an information generation processing of generating second depth information that is information regarding a distance in the depth direction when the virtual object is viewed from a second viewpoint having parallax with respect to the first viewpoint on a basis of the first depth information; and
execute an image generation processing of generating a second image that is an image of the virtual object viewed from the second viewpoint on a basis of the first image and the first depth information and of generating a combined image of the second viewpoint in which a depth of the virtual object in a space viewed from the second viewpoint is expressed on a basis of the second depth information and the second image.

2. The electronic device according to claim 1, wherein
in the acquisition processing, an image of the space viewed from the first viewpoint is further acquired, and
in the image generation processing, a combined image of the first viewpoint in which a depth of the virtual object in the space viewed from the first viewpoint is expressed is generated on a basis of the first depth information and the first image.

3. The electronic device according to claim 2, wherein
the space is a real space, and
in the image generation processing, a combined image of the first viewpoint and a combined image of the second viewpoint are generated on a basis of a captured image obtained by imaging the real space.

4. The electronic device according to claim 3, wherein
in the information generation processing, depth information of the real space is generated on a basis of the captured image.

5. The electronic device according to claim 3, wherein
in the information generation processing, depth information of the real space is acquired using at least one of a LiDAR sensor, a ToF sensor, or a millimeter wave radar.

6. The electronic device according to claim 2, wherein
the space is a virtual space, and
in the image generation processing, a combined image of the first viewpoint and a combined image of the second viewpoint are generated on a basis of an image of the virtual space.

7. The electronic device according to claim 1, wherein
in the image generation processing, the second image is generated by performing perspective projection transformation on the first image.

8. The electronic device according to claim 1, wherein
in the information generation processing, the second depth information is generated on a basis of the second image generated in the image generation processing.

9. The electronic device according to claim 1, wherein
in the image generation processing, a missing region in the second image is interpolated on a basis of information of surrounding pixels.

10. The electronic device according to claim 1, wherein
in the information generation processing, the second depth information is generated by performing perspective projection transformation on the first depth information.

11. The electronic device according to claim 1, wherein
in the acquisition processing, difference depth information that is a difference between the first depth information and the second depth information is further acquired from the external apparatus, and
in the information generation processing, the second depth information is generated on a basis of the first depth information and the difference depth information.

12. The electronic device according to claim 1, wherein
in the information generation processing, a missing portion of the second depth information is interpolated on a basis of depth information of surrounding pixels.

13. The electronic device according to claim 1, wherein
the one or more processors are further configured to execute a drawing processing of drawing a second virtual object different from the virtual object, and
in the image generation processing, by combining the second image and an image of the second virtual object on a basis of depth information of the second virtual object that is information regarding a distance in the depth direction when the second virtual object is viewed from the second viewpoint and the second depth information, an image in which a depth relationship between the virtual object and the second virtual object in the space viewed from the second viewpoint is generated.

14. The electronic device according to claim 1, wherein
in the acquisition processing, information acquired from the external apparatus in order to generate the second depth information and the second image are changed according to a predetermined condition.

15. The electronic device according to claim 14, wherein
the predetermined condition includes at least one of a transmission capacity with the external apparatus or a distance to the virtual object.

16. An electronic device comprising:
a communication interface; and
one or more processors configured to:
execute an acquisition processing of acquiring, from an external apparatus, a difference image related to an image region invisible when viewed from a first viewpoint among a first image that is an image of a virtual object viewed from the first viewpoint, first depth information that is information regarding a distance in a depth direction when the virtual object is viewed from the first viewpoint, and the virtual object viewed from a second viewpoint having parallax with respect to the first viewpoint;
execute an information generation processing of generating second depth information that is information regarding a distance in the depth direction when the virtual object is viewed from the second viewpoint on a basis of the first depth information; and
execute an image generation processing of generating a second image that is an image of the virtual object viewed from the second viewpoint on a basis of the first image and the difference image and of generating a combined image of the second viewpoint in which a depth of the virtual object in a space viewed from the second viewpoint is expressed on a basis of the second depth information and the second image.

17. A method for controlling an electronic device, the method comprising:
acquiring, from an external apparatus, a first image that is an image of a virtual object viewed from a first viewpoint and first depth information that is information regarding a distance in a depth direction when the virtual object is viewed from the first viewpoint;
generating second depth information that is information regarding a distance in the depth direction when the virtual object is viewed from a second viewpoint having parallax with respect to the first viewpoint on a basis of the first depth information; and
generating a second image that is an image of the virtual object viewed from the second viewpoint on a basis of the first image and the first depth information, and generating a combined image of the second viewpoint in which a depth of the virtual object in a space viewed from the second viewpoint is expressed on a basis of the second depth information and the second image.

18. A non-transitory computer-readable medium that stores computer-executable instructions, wherein the computer-executable instructions cause a computer to execute a method for controlling an electronic device, the method comprising:
acquiring, from an external apparatus, a first image that is an image of a virtual object viewed from a first viewpoint and first depth information that is information regarding a distance in a depth direction when the virtual object is viewed from the first viewpoint;
generating second depth information that is information regarding a distance in the depth direction when the virtual object is viewed from a second viewpoint having parallax with respect to the first viewpoint on a basis of the first depth information; and
generating a second image that is an image of the virtual object viewed from the second viewpoint on a basis of the first image and the first depth information, and generating a combined image of the second viewpoint in which a depth of the virtual object in a space viewed from the second viewpoint is expressed on a basis of the second depth information and the second image.
